(19) United States
(12) Patent Application Publication
(10) Pub. No.: US 2024/0419966 A1
(43) Pub. Date: Dec. 19, 2024

(54) SYSTEM AND METHOD FOR LABEL ERROR DETECTION VIA CLUSTERING TRAINING LOSSES

(71) Applicant: The Trustees of Princeton University, Princeton, NJ (US)

(72) Inventors: Chang Yue, Princeton, NJ (US); Niraj K. Jha, Princeton, NJ (US)

(73) Assignee: The Trustees of Princeton University, Princeton, NJ (US)

(21) Appl. No.: 18/743,768

(22) Filed: Jun. 14, 2024

Related U.S. Application Data
(60) Provisional application No. 63/521,182, filed on Jun. 15, 2023.

(51) Int. Cl. G06N 3/08

(52) U.S. Cl. CPC G06N 3/08

(57) ABSTRACT

Systems and methods for tackling a significant problem in data analytics: inaccurate dataset labeling. Such inaccuracies can compromise machine learning model performance. To counter this, label error detection algorithm is provided that efficiently identifies and removes samples with corrupted labels. The provided framework (CTRL) detects label errors in two steps based on the observation that models learn clean and noisy labels in different ways. First, one trains a neural network using the noisy training dataset and obtains the loss curve for each sample. Then, one applies clustering algorithms to the training losses to group samples into two categories: cleanly-labeled and noisily-labeled. After label error detection, one removes samples with noisy labels and retrains the model.

### CROSS-REFERENCE TO RELATED APPLICATIONS

The present application claims priority to U.S. Provisional Patent Application No. 63/521,182, filed Jun. 15, 2023, the contents of which are incorporated by reference herein.

### STATEMENT REGARDING FEDERALLY SPONSORED RESEARCH OR DEVELOPMENT

This invention was made with government support under Grant No. CNS- 1907381 awarded by the National Science Foundation. The government has certain rights in the invention.

### TECHNICAL FIELD

The present disclosure is drawn to techniques for detecting label errors, and specifically, to clustering training losses for label errors detection.

### BACKGROUND

In supervised machine learning, use of correct labels is extremely important to ensure high accuracy. Unfortunately, most datasets contain corrupted labels. Machine learning models trained on such datasets do not generalize well. Thus, detecting their label errors can significantly increase their efficacy.

### BRIEF SUMMARY

In various aspects, a method for training a neural network to detect label errors may be provided. The method may include training a neural network on the noisy training dataset. The neural network may produce one or more training loss data samples for each epoch of a plurality of training epochs. The training may include recording training loss of each data sample in every epoch. The training may include creating a loss matrix, wherein the loss matrix is constructed as: |training loss samples|×|epochs|. The method may include forming a refined neural network by refining the neural network. Refining may include applying a clustering algorithm to the loss matrix. The clustering algorithm may be configured to separate samples into either a category of clean labels or noisy labels. The method may include removing noisy labels before a subsequent period of training. The method may include dynamically replacing noisy labels with a prediction of a neural network during a period of training. The method may include statically replacing noisy labels with a prediction of a neural network, updated before a period of training by using the training of a previous round of the neural network. The method may include using the refined neural network to classify an image of a label as a label defect. The method may include using the refined neural network to classify non-image data. The method may include using the refined neural network to classify data in a tabular dataset. The method may include using a noise generator to create a noisy training dataset.

In various aspects, a system for detecting label errors may be provided, the system may include at least one processing unit. The system may include at least one non-transitory computer readable storage medium storing instructions that, when executed by the at least one processing unit, cause the at least one processing unit to, collectively, perform steps of an embodiment of a method as disclosed herein. The system may include a remote processing unit. The refined neural network may be transmitted to a remote processing unit for use in classifying images as clean labels or noisy labels. The system may include a requestor computing device. The requestor computing device may be configured to send a request to the at least one processing unit to classify an image of a label as a clean label or a noisy label.

In various aspects, a non-transitory computer readable storage medium, containing instructions thereon that, when executed by at least one processing unit, cause the at least one processing unit to, collectively, perform steps of an embodiment of a method as disclosed herein.

### BRIEF DESCRIPTION OF DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a schematic illustration of a system.

FIG. 2 is a flowchart of a method.

FIG. 3 is a schematic overview of the workflow of the CTRL methodology and its testing process.

FIG. 4 is a mask computation algorithm.

FIG. 5 is a depiction of loss matrix L, epochs, and samples.

FIG. 6 is a graph showing training losses of clean and noisy labels on CIFAR-100, with 17% noise and 60% sparsity. Different label types typically have different loss curves.

FIG. 7 is an example of windowing, showing 5 samples, 4 windows, and a threshold of 3.

FIGS. 8A and 8B are mean last-5-epoch-loss histograms under noisy settings: CIFAR-10 (8A) (20% noise and 60% sparsity) and CIFAR-100 (8B) (17% noise and 60% sparsity). Note the scaling difference on the loss axes.

FIG. 9 is a table (Table I) showing characteristics of the post-processed datasets.

FIG. 10 is a table (Table II) showing mask accuracy and model test accuracy over three trials under asymmetric label noise for CIFAR-10.

FIG. 11 is a table (Table III) showing mask accuracy and model test accuracy over three trials under asymmetric label noise for CIFAR-100.

FIG. 12 is a table (Table IV) showing mask accuracy and model test accuracy over three trials under asymmetric label noise for Food-101.

FIG. 13 is a table (Table V) showing mask accuracy and model test accuracy over three trials under asymmetric label noise for Fashion-MNIST.

FIG. 14 is a table (Table VI) showing mask accuracy and model test accuracy over ten trials under asymmetric label noise for tabular datasets.

FIG. 15 is a table (Table VIII) showing additional mask accuracy and model test accuracy results for CIFAR-10.

FIG. 16 is a table (Table IX) showing additional mask accuracy and model test accuracy results for CIFAR-100.

FIG. 17 is a table (Table X) showing additional mask accuracy and model test accuracy results for tabular datasets.

FIG. 18 is an example asymmetric noise transition matrix for CIFAR-10, with 20% noise and 60% sparsity.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term “or” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Disclosed herein is a framework for detecting clustering training losses for label error detection (called CTRL-Clustering TRaining Losses for label error detection) that allows for the detection of label errors in multi-class datasets.

The CTRL framework disclosed herein detects label errors in two steps based on the observation that models learn clean and noisy labels in different ways. First, one trains a neural network using the noisy training dataset and obtains the loss curve for each sample. Then, one applies clustering algorithms to the training losses to group samples into two categories: cleanly-labeled and noisily-labeled. After label error detection, one removes samples with noisy labels and retrains the model. Experimental results demonstrate state-of-the-art error detection accuracy on both image and tabular datasets under labeling noise.

More particularly, the disclosed algorithm can be used to clean classification datasets. It collects the training loss curves of samples within a dataset and identifies samples with incorrect labels. This approach differs from previous algorithms, such as those that use cross-validated predictions to calculate confusion matrices. It can detect labeling errors in any classification dataset. Since many datasets, including popular ones, have been found to contain labeling errors, the disclosed algorithm has broad potential for application. According to experiments that were conducted, CTRL achieved the best detection accuracies on many popular dataset benchmarks. It was also found that improved label error detection leads to more accurate trained models.

More broadly, the algorithm disclosed herein detects labeling errors in classification datasets, which can be applied to any classification dataset to filter out wrongly labeled instances.

The disclosed process employs two important steps. The first step involves training a neural network with the noisy training dataset to obtain a loss curve for each sample. In the second step, clustering algorithms are applied to the training losses, which groups the samples into two categories: cleanly-labeled and noisily-labeled. Since CTRL is a process used to clean datasets, it incorporates an extra step for cleaning. This step can be accelerated by subsampling the training curve. Furthermore, CTRL is fast, especially when compared to most existing cleaning methods.

A strength of the disclosed approach is its ability to enhance the accuracy of classification tasks; machine learning models trained on data cleaned using the disclosed algorithm can see a balanced-class accuracy boost of over 10% at around a 20% noise rate. Since it is not restricted to specific datasets, the disclosed algorithm can be broadly applied to any multi-class dataset. With potential for integration into existing data analytics software or as a standalone product, the disclosed approach offers data scientists a powerful tool to bolster the precision and efficiency of their work.

The disclosed process could either be integrated into existing data analytics software suites or serve as a standalone product specifically focused on dataset label cleaning. Data scientists could readily download this tool and incorporate it into their data analytics projects, thereby enhancing the efficiency and accuracy of their work. The disclosed method stands out for, inter alia, both its precision and its ease of use.

In various aspects, a system for detecting label errors may be provided.

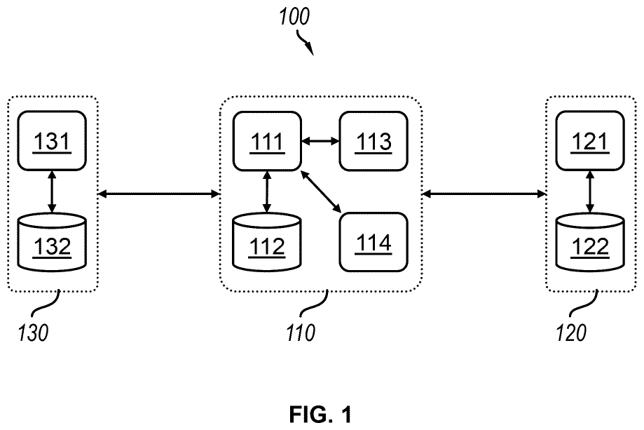

Referring to FIG. 1, a system (100) may include at least one a provider computing device (110). The provider computing device may include one or more processing units (111), one or more non-transitory computer readable storage media (112), memory (113), and one or more input/output devices or connections (114) (such as connections for ethernet, wireless connections, keyboards, displays, etc.). As used herein, the term “processing unit” generally refers to a computational device capable of accepting data and performing mathematical and logical operations as instructed by program instructions. This may include any central processing unit (CPU), graphics processing unit (GPU), core, hardware thread, or other processing construct known or later developed. The term “thread” is used herein to refer to any software or processing unit or arrangement thereof that is configured to support the concurrent execution of multiple operations.

The system may include a requestor computing device (120) operably coupled to the provider computing device (e.g., over one or more networks). The requestor computing device may include processing unit(s) (121) operably coupled to non-transitory computer-readable storage medium/media (122). The requestor computing device may be configured to send a request to the at least one processing unit (111), the request being to classify, e.g., an image of a label as a clean label or a noisy label.

The system may include a remote computing device (130) operably coupled to the provider device. The remote computing device may include processing unit(s) (131) operably coupled to non-transitory computer-readable storage medium/media (132). The remote computing device may be configured to perform some or all of the steps of a method in combination with the provider computing device. A neural network may be transmitted to a remote processing unit (e.g., processing unit(s) (131)) for use in classifying images as clean labels or noisy labels. For example, in some embodiments, a requestor computing device may send a request for classification to a provider computing device. The provider computing device may, e.g., train/refine a neural network, and then send that refined neural network to a remote computing device in order to perform the classification using the refined neural network.

The non-transitory computer readable storage media may store instructions that, when executed by the at least one processing unit, cause the at least one processing unit to perform various steps of a method.

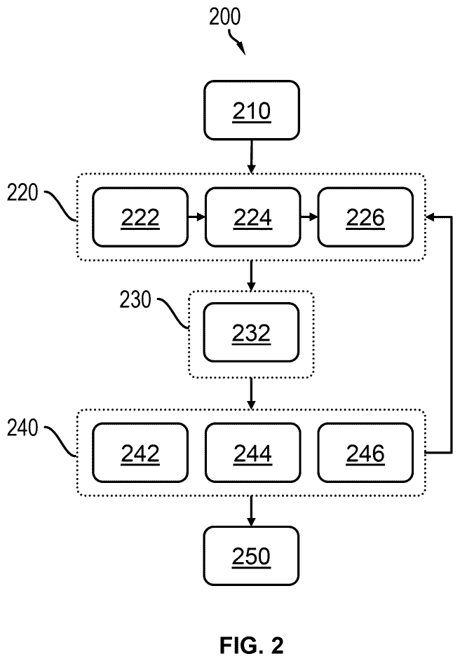

In various aspects, a method for training a neural network to detect label errors may be provided. Referring to FIG. 2, the method (200) may include creating (210) a noisy training dataset. This may include using a noise generator to create the noisy training dataset.

The method may include training (220) a neural network on the noisy training dataset. The training may include producing (222) one or more training loss data samples for each epoch of a plurality of training epochs. The training may include recording (224) training loss of each data sample in every epoch. The training may include creating (226) a loss matrix, wherein the loss matrix is constructed as: |training loss samples|×|epochs|.

The method may include forming (230) a refined neural network by refining the neural network. Refining may include applying (232) a clustering algorithm to the loss matrix. The clustering algorithm may be configured to separate samples into either a category of clean labels or noisy labels.

The method may include cleaning (240) the training data. This may include removing (242) noisy labels before a subsequent period of training. This may include dynamically replacing (244) noisy labels with a prediction of a neural network during a period of training. The method may include statically replacing (246) noisy labels with a prediction of a neural network, updated before a period of training by using the training of a previous round of the neural network.

The method may include using (250) the refined neural network to identify errors, such as classifying an image of a label as a label defect, or identifying data in a tabular dataset as containing errors.

In some embodiments, any identified erroneous data may be removed from the dataset. For example, if a large tabular dataset is found to include errors, those errors may be removed from the tabular dataset. If an image is found to be incorrectly labeled, the label may be removed from, e.g., the image's metadata.

There are different types of noise. Some are modeled by a | [symbol] |×| [symbol] |noise transition matrix T, where | [symbol] | denotes the number of classes. In this matrix, T(i, j) represents the probability of a sample labeled as class i given that its actual hidden class is j. Two properties describe the noise transition matrix. The first is noise level, which is the sum of all the off-diagonal entries divided by the number of classes. The second is sparsity level, which is the number of zero entries divided by the number of off-diagonal entries. In the case of symmetric noise, entries have the same value on the diagonal and a uniform probability off-diagonal. Asymmetric noise imposes fewer constraints. Hence, the transition probabilities need not be symmetric as above. In semantic noise, each instance has its own noise transition matrix. There is also open noise, which occurs when the ground-truth label set is different from the observed set.

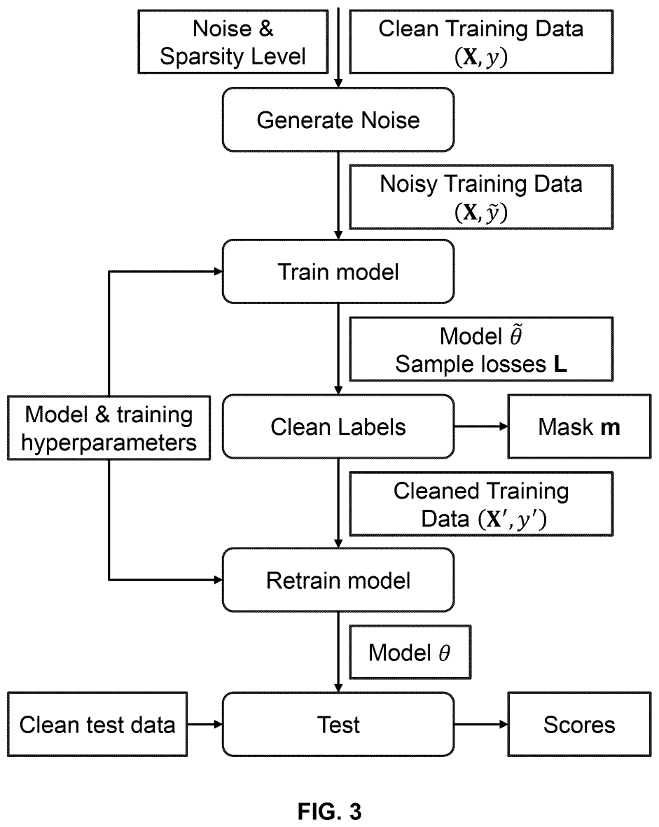

FIG. 3 shows an overview of the basic methodology. First, a noise generator is used to create noisy labels if the dataset is originally clean. The input to the noise generator is the noise rate and the sparsity level of the noise transition matrix. Noise may not be injected if the dataset already contains real-world noise. A model is then trained using the noisy data and the training losses are recorded. After that, the model and loss matrix are passed to a label cleaning algorithm, which outputs a binary mask (1 indicates clean and 0 noisy) and the cleaned training data. Finally, the model is retrained on the cleaned data and its test accuracy is obtained.

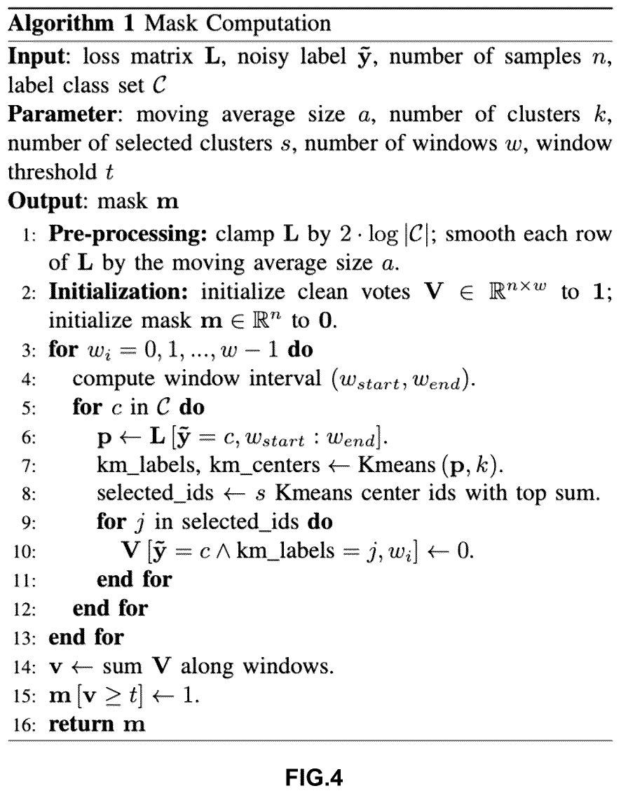

Algorithm 1 (see FIG. 4) presents the mask computation process of CTRL. The inputs are the matrix of training sample loss curves L, the provided labels \tilde{y} which are potentially noisy, the number of samples n, and the set of label classes [symbol] . Any outliers in the loss matrix are clamped, and the loss curve is smoothed for each sample by a mean filter. L is split into equal-length intervals by epoch number. After that, further break the loss matrix by the provided label class and run the clustering algorithm for each class of samples. Lines 6-11 show the core clustering algorithm that classifies the samples based on their loss trajectories. The samples are grouped into k clusters and assign s clusters with larger areas under the loss curve as noisy. k and s are input parameters. In every window, there is a mask value for each sample. Finally, the mask scores are summed across windows and a sample is classified as noisy if it is marked as noisy in enough windows.

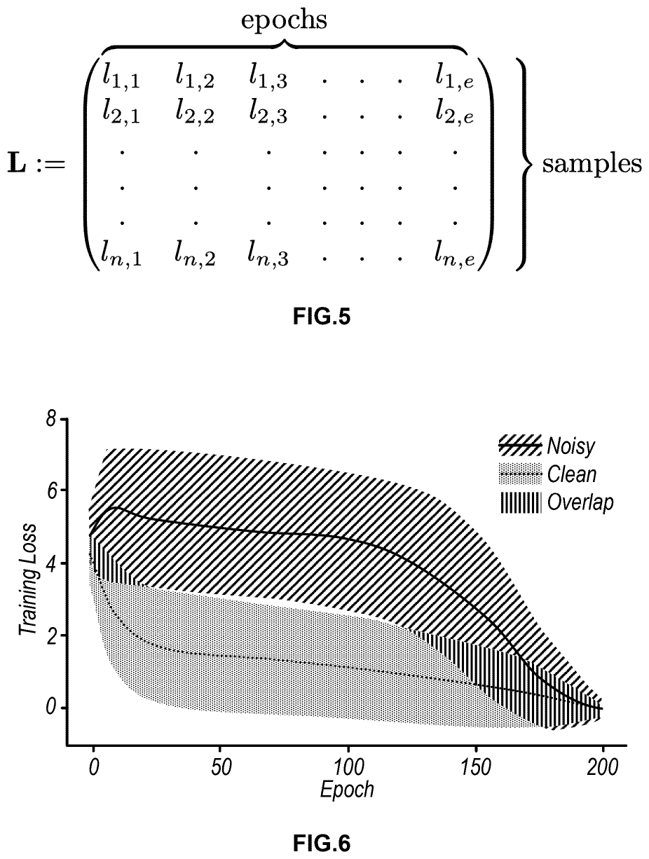

During training, the loss of each data sample is recorded in every epoch. This results in a |samples|×|epochs| loss matrix L. See FIG. 5.

Based on the observation that clean and noisy samples have different loss curves, a clustering algorithm can be applied to the loss curves to group labels into two classes. FIG. 6 shows an example of the average training losses of different label types on the well-known CIFAR-100 image dataset, with a 17% noise level and 60% sparsity level. The average loss gap between clean and noisy labels during most of the training is quite evident. The decreasing lower (dotted pattern) curve indicates that the NN consistently learns from clean samples. However, it does not learn well from the noisy samples initially, as demonstrated by the average losses staying roughly constant for a long time. As the loss gap increases, the gradient caused by noisy labels starts playing a more important role, and the model also starts learning from them. It eventually learns from every sample. Similar gaps were found in all datasets that were experimented with. Another observation is that the loss curves are class-dependent. Still, dividing samples based on their labeled class can improve label error detection accuracy, especially when the noise rate is not too high (e.g., less than 20%). The presently disclosed approach may run the clustering algorithm on each class separately.

Although the average loss curves in FIG. 6 are shown as being smooth, that is only for the sake of simplicity. Certainly, at the data sample level, they have a large variance.

In some embodiments, to smooth out the loss curves for each sample, losses are clamped to a threshold of 2·log| [symbol] |(about two times the expected cross-entropy loss of a randomly-initialized NN) and the moving averages are computed with a window size of 5. In practice, it has been found that the effects of different loss thresholds and moving average window sizes are typically small.

The basic trends on loss curves are stable. Due to the fact that each point on the smoothed loss curve contains information from multiple epochs, in some embodiments, only a subset of the loss matrix was used for label error detection. Three sampling methods were tested at various subsampling ratios. This included sampling uniformly, sampling the middle numbers of epochs, or sampling epochs with high intra-epoch loss variances. It was found that relative to the use of the full loss matrix, uniform subsampling by up to 8× demonstrates close performance.

### Clustering Algorithm

Based on speed and robustness considerations, K-means was used as the core clustering algorithm. The method may be applicable to large datasets. Among popular clustering algorithms, including DBSCAN and BIRCH, only K-means and Gaussian Mixture Model (GMM) are time-efficient. However, due to its use of mixtures, GMM has a higher uncertainty. K-means is more robust because its cluster assignments are one-hot.

K-means employs one parameter, the number of clusters, k. Since mask assignment is binary in our methodology, only two final clusters are needed. Therefore, another parameter, the number of selected clusters, s, may be employed to divide multiple clusters into two groups when k is greater than two. With k clusters, the sum of their cluster centers are sorted and samples from the top s clusters as denoted as noisily-labeled. In some embodiments, three

$$( \begin{matrix}k \\ s\end{matrix} )$$

values may be considered, i.e.,

$$( \begin{matrix}2 \\ 1\end{matrix} ) , ( \begin{matrix}3 \\ 1\end{matrix} ) , and ( \begin{matrix}3 \\ 2\end{matrix} ) .$$

### Controlling the Detection Sensitivity to Noisy Labels

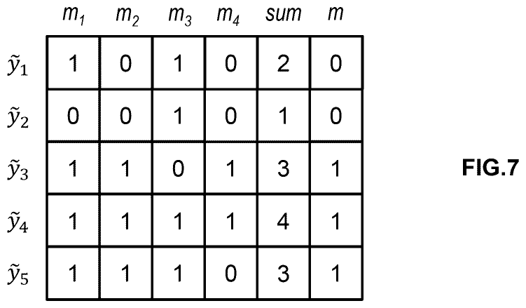

To adjust the detection sensitivity to noisy labels, one can employ a divide-and-vote approach. The loss matrix may be divided into several windows and the clustering algorithm may be run on each window. Hence, each window outputs a mask. All masks may be summed up, and a threshold function may be applied on the sum to make the final mask binary. FIG. 7 illustrates a four-window example containing five samples. The sum represents the total clean score (because 1 represents clean in a mask). Hence, it is the number of windows that classify the sample as clean. In this example, a threshold t=3 was apply to the votes to yield the final mask. A smaller (or larger) threshold would make the algorithm more (or less) sensitive to label noise.

In this windowing technique, we introduced two more parameters: the number of windows w and the window threshold t. In various experiments, one, two, and four windows have been tested, and for each window choice w, thresholds t ranging from 1 to

$$[ \frac{w}{2} ] + 1$$

were tried. Hence, there were six (w, t) pairs in all, i.e., (1, 1), (2, 1), (2, 2), (4, 1), (4, 2), and (4, 3).

### Determining the Best Mask

The label error detection algorithm may have, e.g., four clustering parameters in all: number of clusters, number of selected clusters, number of windows, and the window threshold. A metric may be needed to obtain the best set of values for these clustering parameters. There is no conventional rubric to measure the quality of cluster assignments. One possible metric is the Silhouette Score. For each sample, its Silhouette Coefficient denotes the scaled difference between its mean intra-cluster distance and its mean nearest-cluster distance. The Silhouette Score of a dataset is the average Silhouette Coefficients of all its samples. A drawback of the Silhouette Score is that it does not always select the best assignment. One solution is to consider the training outputs in addition to the Silhouette Score. Thus, one can use:

$$score ( m , L , \tilde{θ} ) = silhouette ( m , L ) \times {[ train\_acc ( m , \tilde{θ} ) \times loss\_ratio ( m , L ) ]}^{α} \qquad ( 1 )$$

This equation has two parts. The first part is the regular Silhouette Score, which measures clustering quality. The other part measures the mask quality by calculating the product of masked training accuracy and the ratio between mean marked-noisy sample loss and mean marked-clean sample loss. The last loss value of the smoothed loss curve is used, which may be averaged over multiple previous epochs (in the example case, over the previous five epochs). The use of masked training accuracy helps because models tend to learn more correctly labeled samples than incorrectly labeled ones. This learning difference is also reflected in losses. The strength of the masked score may be controlled by raising its power to a, which depends on model convergence. When the model overfits all samples, its masked accuracy depends less on the quality of the mask because it correctly predicts almost all samples. In the example case, the loss ratios are largely governed by outliers. However, when the model is robust against noisy labels, it demonstrates different convergences on different label types. In the example case, its masked score should be assigned a higher weight. One can get model robustness information by checking its loss histogram.

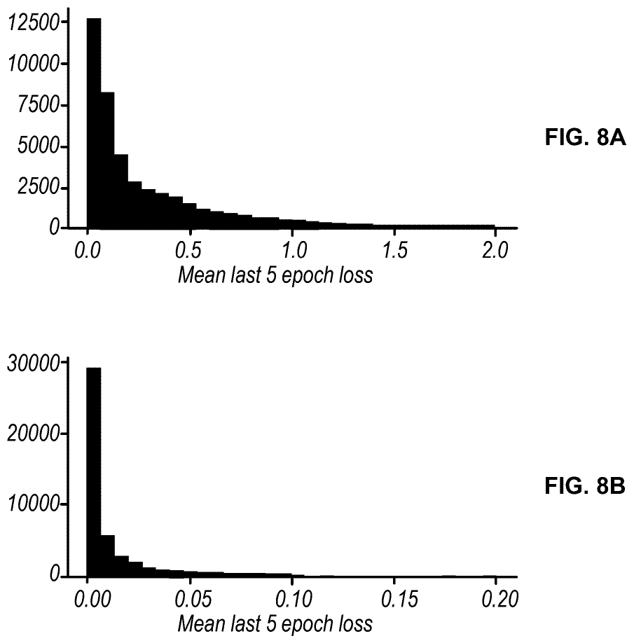

With the selection of the model architecture and the training hyperparameters, CIFAR-10 and CIFAR-100 based NN models converge quite differently, with the CIFAR-10 based model being much more robust to label errors. FIGS. 8A and 8B shows histograms of the mean loss over the last five epochs for the two datasets (CIFAR-10, 20% noise, and 60% sparsity: FIG. 8A; CIFAR-100, 17% noise, and 60% sparsity: FIG. 8B). The following values of a were tried: 0, 0.25, 0.5, and 1. While they all generally result in better detection accuracies than other methods, different α's result in different masks. Hence, selecting a suitable value for a is still important. An α of 1 was chosen for CIFAR-10, and an α of 0.25 for CIFAR- 100. The Silhouette Score was only used for tabular datasets because their training convergence is less stable. The choice of a may be automated based on loss histograms.

### Cleaning the Dataset and Retraining the Model

The next steps are to clean the dataset and then retrain the model using the cleaned data. The simplest way to clean is to remove all wrongly-labeled samples. This method is efficient. There are many other ways to use the mask. In one example, all samples were generally kept, but bad labels were replaced with the model's prediction, either dynamically (update every epoch during a training period) or statically (update before training by using the model trained in the first round). Under limited tests, the dynamic replacement method generally results in better test accuracies than the static method, and just pruning away bad labels outperforms both replacement methods.

### Loss Gap Analysis for a Simple Problem

A theoretical analysis of the loss gap is presented. Consider a balanced two-class clean dataset that contains n independent samples in [symbol] ^{d}. The feature x is sampled from

$$x ∼ 𝒩 ( + v , {σ}^{2} {I}_{d \times d} ) \qquad if y = + 1 ,$$

$$x ∼ 𝒩 ( - v , {σ}^{2} {I}_{d \times d} ) \qquad if y = - 1 ,$$

where ∥v∥=1 and σ² is small. Denote by y the true hidden label and by \tilde{y} the observed label. Subscripts are used on x and y to index samples. Assume that for any sample i,

$${\tilde{y}}_{i} = \{ \begin{matrix}{y}_{i} , & with probability 1 - Δ \\ - {y}_{i} , & with probability Δ\end{matrix} .$$

where

$$Δ ∈ ( 0 , \frac{1}{2} )$$

is the noise level. [symbol] is used to denote the set of indices whose corresponding samples have clean labels and [symbol] for the noisy ones.

Consider a two-layer sigmoid NN with parameter θ∈ [symbol] ^{d} that makes class probability predictions p for input x as follows:

$$p ( y = 1 ) = sig ( {θ}^{T} x ) = \frac{1}{1 + {e}^{- {θ}^{{T}_{x}}}} ,$$

$$p ( y = - 1 ) = 1 - p ( y = 1 )$$

In the beginning, θ is initialized to 0, denoted as θ₀. Log loss is used for gradient descent, and for proof simplicity, each sample loss lᵢ is clamped to B, where B≥1. The average loss is then

$$\begin{matrix}l ( θ ) & = \frac{1}{n} {\sum }_{i = 1}^{n} min \{ {l}_{i} ( θ ) , B \} \\ & = \frac{1}{n} {\sum }_{i = 1}^{n} min \{ log ( 1 + {e}^{- {\tilde{y}}_{i} {θ}^{T} {x}_{i}} ) , B \}\end{matrix}$$

In the first epoch, lᵢ(θ₀)=log(2)<B because θ₀ is zero. The gradient is then

$$\begin{matrix}{∇}_{{θ}_{0}} l ( {θ}_{0} ) & = \frac{1}{2 n} {\sum }_{i = 1}^{n} {x}_{i} \cdot ( tanh ( \frac{1}{2} {θ}_{0}^{T} {x}_{i} ) - {\tilde{y}}_{i} ) \\ & = \frac{1}{2 n} {\sum }_{i = 1}^{n} - {\tilde{y}}_{i} {x}_{i}\end{matrix} .$$

$${v}^{T} ( - {∇}_{{θ}_{0}} l ( {θ}_{0} ) )$$

$$= \frac{1}{2 n} {\sum }_{i = 1}^{n} {\tilde{y}}_{i} {v}^{T} {x}_{i}$$

$$= \frac{1}{2 n} [ {\sum }_{i ∈ 𝒞} {v}^{T} ( v + {z}_{i} ) + {\sum }_{i ∈ 𝒩} {v}^{T} ( - v + {z}_{i} ) ]$$

$$= \frac{1}{2 n} [ {\sum }_{i ∈ 𝒞} ( 1 + {v}^{T} {z}_{i} ) + {\sum }_{i ∈ 𝒩} ( - 1 + {v}^{T} {z}_{i} ) ]$$

$$= \frac{1}{2} ( 1 - 2 Δ ) + \frac{1}{2 n} {\sum }_{i = 1}^{n} {w}_{i}$$

where zᵢ˜ [symbol] (0, σ²I_{dxd}) is the added vector deviation on xᵢ. The last step is derived from the fact that, without loss of generality, by taking v as a standard basis vector and by the symmetry of the Normal distribution, one can replace V^{T}zᵢ by a scalar wᵢ where wᵢ˜ [symbol] (0, σ²). By Hoeffding's Inequality, with probability≥1−p,

$${v}^{T} ( - {∇}_{{θ}_{0}} l ( {θ}_{0} ) ) \geq \frac{1}{2} ( 1 - 2 Δ ) - 𝒪 ( \frac{σ}{\sqrt{n}} \sqrt{log \frac{1}{p}} ) .$$

Assume a learning rate of η is used. Then, after the first epoch, one has θ₁=−η·∇_{θ}_{₀}l. Based on the above analysis, with high probability, one can conclude:

$$\frac{{v}^{T} {θ}_{1}}{‖ {θ}_{1} ‖} \geq 1 - \tilde{𝒪} ( \frac{σ}{\sqrt{n}} ) . \qquad ( 2 )$$

This indicates that there is a high chance of getting model parameters close to the optimal after one epoch. Prior work has shown a derivation of gradient and parameter changes under a similar setting over more epochs and shows that θₜ would initially be well correlated with v for a period. This phenomenon is called early learning. However, the analysis gets much more complicated for ResNets on the CIFAR-10/CIFAR-100 datasets, in which there are complex relations between classes and each sample's loss curve fluctuates under gradient descent. Hence, one needs to consider a period larger than one epoch, e.g., the whole training duration.

Next is the analysis of the loss gap between clean and noisy samples during early learning. For j∈ [symbol] ,

$${l}_{j} ( θ ) = min \{ log ( 1 + {e}^{- {θ}^{T} ( v + {z}_{j} )} ) , B \} \leq {e}^{- {θ}^{T} ( v + {z}_{j} )}$$

because log(1+x)≤x for x≥0. Knowing that

$$log ( 1 + x ) \geq \frac{1}{1 + {x}^{- 1}} \geq 1 - {x}^{- 1}$$

for x>0, then for k∈ [symbol] ,

$$\begin{matrix}{l}_{k} ( θ ) & = min \{ log ( 1 + {e}^{{θ}^{T} ( v + {z}_{k} )} ) , B \} \\ & \geq min \{ 1 - {e}^{- {θ}^{T} ( v + {z}_{k} )} , B \} \\ & = 1 - {e}^{- {θ}^{T} ( v + {z}_{k} )}\end{matrix} .$$

Taking the expectation on the difference between clean and noisy label losses, one gets

$$\begin{matrix}𝔼 [ {l}_{k} ( θ ) - {l}_{j} ( θ ) ] & = 𝔼 [ {l}_{k} ( θ ) ] - 𝔼 [ {l}_{j} ( θ ) ] \\ & \geq 1 - 2 \cdot 𝔼 [ {e}^{- {θ}^{T} ( v + z )} ]\end{matrix} .$$

The term 1−2· [symbol] [e^{-θ}^{^{T}}^{(v+z)}] bounds the expected loss gap between clean and noisy labels. It is independent of the label type.

$$\begin{matrix}𝔼 [ {e}^{- {θ}^{T} ( v + z )} ] & = {e}^{- {θ}^{T} v} \cdot 𝔼 [ {e}^{- {θ}^{T} z} ] \\ & = {e}^{- {θ}^{T} v} \cdot {𝔼}_{w ∼ 𝒩 ( 0 , {σ}^{2} )} [ {e}^{‖ θ ‖ w} ] \\ & = {e}^{- {θ}^{T} v} \cdot {e}^{\frac{1}{2} {‖ θ ‖}^{2} {σ}^{2}}\end{matrix} .$$

The smaller the σ or the larger the projection θ has on v, the larger the expected loss gap. Luckily, from Eq. 2, one knows it is not hard to obtain a good θ. Letting the average losses of clean and noisy labels be defined as

$${l}_{clean} = \frac{1}{{n}_{c}} {\sum }_{i ∈ 𝒞} {l}_{i} and {l}_{noisy} = \frac{1}{{n}_{n}} {\sum }_{i ∈ 𝒩} {l}_{i} ,$$

respectively. By Hoeffding's Inequality on bounded variables and the Union Bound, one can obtain with probability≥1−p,

$${l}_{clean} \leq 𝔼 [ {l}_{clean} ] + 𝒪 ( \frac{B}{\sqrt{{n}_{c}}} \sqrt{log \frac{1}{p}} ) ,$$

$${l}_{noisy} \geq 𝔼 [ {l}_{noisy} ] - 𝒪 ( \frac{B}{\sqrt{{n}_{n}}} \sqrt{log \frac{1}{p}} ) .$$

For clean samples, the expectation of the average loss is the same as the expectation of the individual loss (lⱼ(θ) above). This is true for noisy samples (lₖ(θ)) as well. Therefore, during the early-learning phase, with high probability,

$${l}_{noisy} - {l}_{clean} \geq 1 - 2 {e}^{- {θ}^{T} v + \frac{1}{2} {‖ θ ‖}^{2} {σ}^{2}} - \tilde{𝒪} ( \frac{1}{\sqrt{n}} ) . \qquad ( 3 )$$

Inequality (3) explains the gap between the average losses, as illustrated by the two curves in FIG. 6.

### Example—Test Results

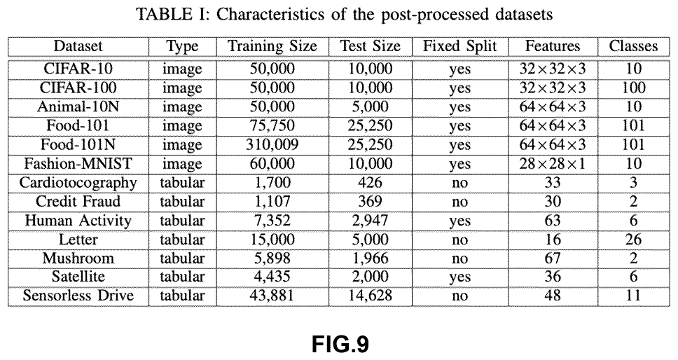

The disclosed label error detection method was tested and compared with previous methods on six image datasets, CIFAR-10 and CIFAR-100, Animal-10N, Food-101, Food-101N, Fashion-MNIST, and seven tabular datasets: Cardiotocography, Credit Fraud, Human Activity Recognition, Letter, Mushroom, Satellite, and Sensorless Drive. Table I (see FIG. 9) describes all datasets after processing. Dataset size ranges from thousands to a third of a million samples, and the number of classes ranges from 2 to 101. In practice, most datasets lie within this range. Each dataset is either split in a fixed manner if the training/test split is provided by the creator or split randomly by us. This example resized images in Food-101 and Food-101N to squares of uniform size, used one-hot categorical features in tabular datasets, and employed principal component analysis to reduce the input dimension of the Human Activity Recognition dataset. Among the six image datasets, Animal-10N and Food-101N contain real-world label errors to which one can directly apply the disclosed method without introducing artificial label noise. The disclosed method can be tested based on simulated asymmetric noise of different noise and sparsity levels for the other four image datasets. Asymmetric noise was used because this type of noise is more common in practice. For each tabular dataset, the method was tested under symmetric noise of different levels because it is infeasible to create asymmetric noise when the number of classes is small. For each dataset, multiple experiments were conducted using different random seeds and report the means and standard deviations. Different methods were evaluated in terms of mask accuracy and the balanced-class test accuracy of models. A random seed controls noise creation, NN training, and split between training and test sets if the split is not originally provided.

The results were compared with the baseline method (in which the provided labels are used directly), Co-teaching, Mixup, and CL. For Co-teaching, the forget rate was set to the actual noise rate and to 0.05 when there is no noise. This could be one of the reasons that Co-teaching performs well in some test cases. For Mixup, the best result was reported across αₘᵢₓᵤₚ∈{1, 2, 4, 8}. CL employs five methods in all, based on different counting and pruning algorithms. The one with the best detection accuracy among the five was reported. Co-teaching and Mixup do not explicitly compute masks. Here, samples with disagreements between their provided labels and the trained model's predictions were treated as noisy.

### Experimental Setup

All experiments were run on Nvidia P100 GPUs and Intel Broadwell E5-2680v4 CPUs.

The scikit-learn packages were used for K-means computation and data processing. NNs were trained using PyTorch. Ray was used for distributed computing.

### Noise Simulation

Image experiments were conducted with asymmetric noise. However, the disclosed method can generalize to symmetric and semantic noise as well. With a clean dataset, the first step is to inject label errors with various levels of noise and sparsity, then test the methods under these scenarios. Cleanlab's noise generation function (see C. Northcutt, et al., “Confident learning: Estimating uncertainty in dataset labels,” J. Artif Intell. Res., vol. 70, pp. 1373-1411, 2021; C. Northcutt, et al., “Learning with confident examples: Rank pruning for robust classification with noisy labels,” in Proc. Conf Uncertain. Artif Intell., 2017.) was used to generate the noise transition matrix by inputting noise level, sparsity level, and random seed.

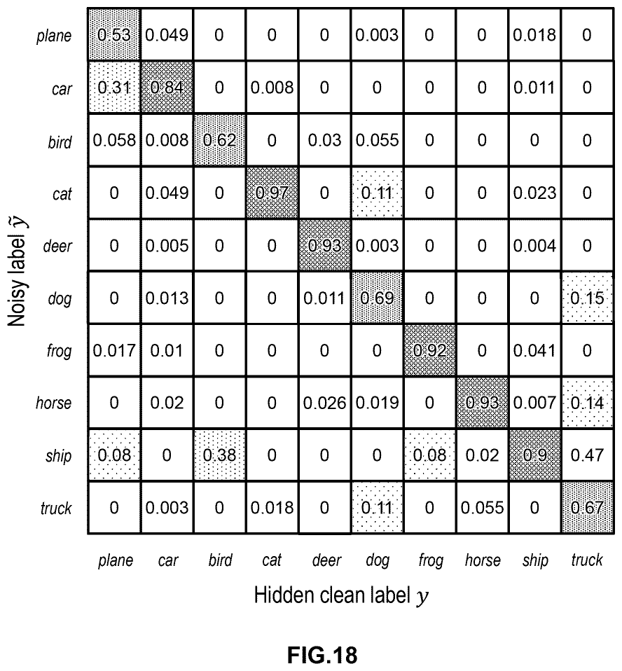

FIG. 18 presents an example of a noise transition matrix for CIFAR-10, with 20% noise and 60% sparsity. The mean of the diagonal represents the proportion of correct labels, which is 0.8 in this case. Sixty percent of the off-diagonal entries have a value of zero. Taking the ‘plane’ class as an example: of all the plane images, 53% are labeled correctly, 31% are labeled as ‘car,’ and 16% are labeled as other classes.

Using a noise transition matrix, Cleanlab can randomly flip some labels based on transition probabilities. Cleanlab's function was used because it has the highest precision among all noise generators investigated. For CIFAR-10 and Fashion-MNIST, methods were tested under noise levels of 0%, 10%, and 20%. For each noise level, sparsity levels of 0%, 20%, 40%, and 60% were simulated. For CIFAR-100, a range of noise levels from 0% to 30% and sparsity levels of 0%, 30%, and 60% were employed. With a larger number of classes (e.g., 100), due to the technical difficulties in generating a matrix targeted at arbitrary levels of noise and sparsity, the noise levels one can simulate depend on the sparsity levels. When both the noise and the sparsity levels are high (e.g., 30% noise and 60% sparsity), some label classes will have noise rates greater than 50%, which is impractical. Therefore, only noise rates not greater than 20% for most datasets were tested. Thus, for Food-101, a range of noise levels from 0% to 20% and sparsity levels of 0%, 20%, 40%, and 60% were employed. Also, since it becomes infeasible to generate asymmetric transition matrices when the number of classes is small, all tabular datasets were tested with 10% and 20% symmetric noise.

### Neural Network Hyperparameters

A hyperparameter set contains the NN architecture, optimizer, batch size, number of epochs, and learning rates. For image datasets, the hyperparameter set provided by an open-source GitHub repository was employed, and was not tuned manually. ResNet-50 was used as the NN architecture and stochastic gradient descent with 0.9 momentum and 5×10⁻⁴ weight decay as the optimizer. The learning rate was started at 0.1 and it was decayed using Cosine Annealing. Models were trained with a batch size of 128 for 200 epochs. It was found that using a smooth learning rate decaying scheduler such as Cosine Annealing and setting its maximum number of iterations to some number slightly larger than the number of epochs helps CTRL detect label errors because this reduces NN overfitting. Hence, the Cosine Annealing iteration number was set to 250 for the mask computation round of CTRL. A value of 200 (same as the number of epochs) was used for training of other models, i.e., Co-teaching's training, Mixup's training, CL's mask computation and retraining, and CTRL's retraining. In the CL article (C. Northcutt, 2021), the authors employed another hyperparameter set. Better mask and test accuracies were obtained for CL with the above set; hence, results for CL using the new hyperparameter set were reported. This hyperparameter set was also used for both Co-teaching and Mixup. For Co-teaching, experiments were run using its original hyperparameter set and report the higher score across the two sets. For each tabular dataset, the same hyperparameter set was used for all training and retraining experiments. A fixed batch size of 1024, a learning rate of 10-3, 0 weight decay, and Adam optimizer was used. NN architecture search was conducted over three-layer and four-layer ReLU-activated NNs with various hidden sizes and numbers of epochs. Grid search was conducted and the hyperparameter set with the best cross-validated balanced-class accuracy on original training data was selected. All methods share the same hyperparameters.

### Image Datasets

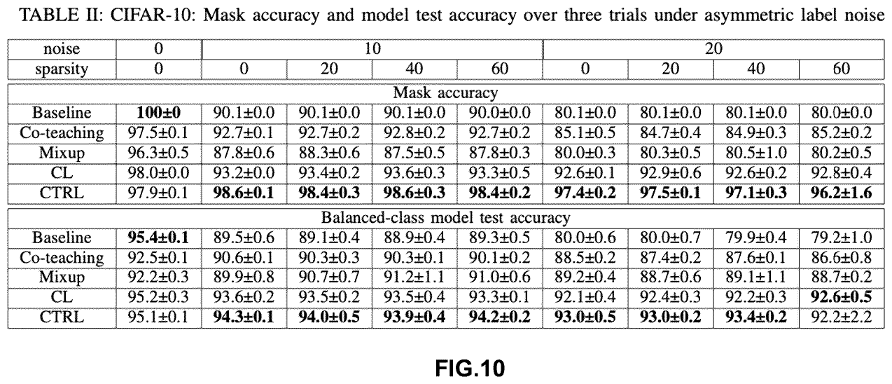

In this section, the results on CIFAR-10, CIFAR-100, Food-101, and Fashion-MNIST were discussed. For each test case, three trials were run. The top half of Table II (see FIG. 10) shows the mean mask accuracies computed on CIFAR-10 under various noise conditions. CTRL outperforms other methods in almost all cases. Generally, CTRL and CL perform better than Co-teaching and Mixup. One advantage of CTRL is its flexibility: the mask selection metric presented in (1) enables CTRL to try different noisy label detection sensitivity levels. CL, on the other hand, results in many false positives: it declares many labels to be erroneous when they are correct but just hard to learn. This is because it only considers the final model state. CTRL improves the label error detection accuracy by examining the entire training process. However, randomness in NN initialization and training may cause a higher variance in the learning process than in the final converged state, resulting in higher variances from CTRL in some cases.

After pruning the labeling errors, the disclosed model is retrained. Table II (see FIG. 10) also shows the model test accuracies. CTRL is superior in most cases, though with higher uncertainties. CTRL performs worse when the noise level is 20% and sparsity level is 60%. This may be because CIFAR-10 has sufficient training samples for each class. Hence, it is better to remove all suspicious samples when labeling noise is complex. This is not the case for CIFAR-100, where each class only has 1 the 10 number of samples in CIFAR-10. Overall, all methods yield a better model than the baseline.

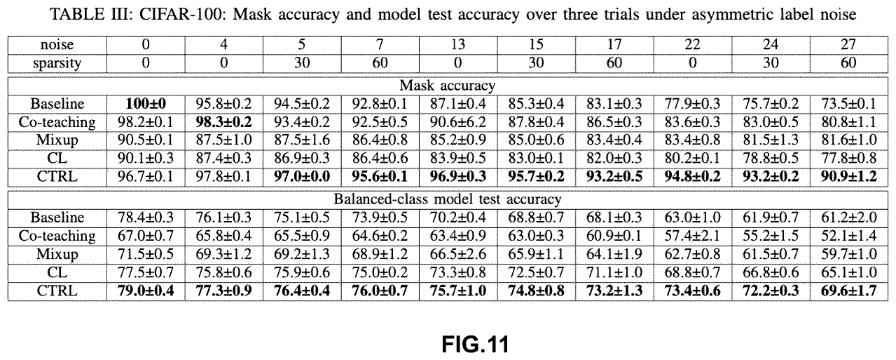

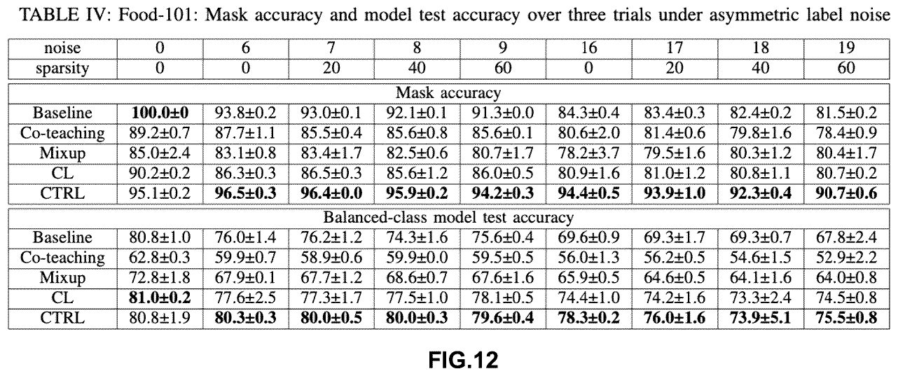

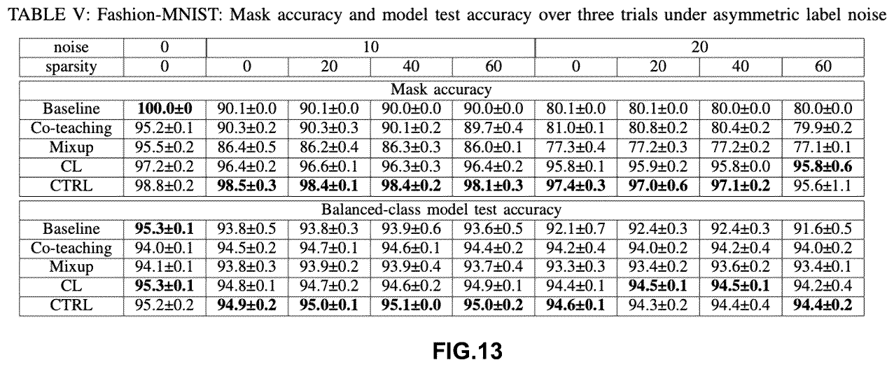

Table III (see FIG. 11) shows the CIFAR-100 mask and test accuracy results. CTRL performs better than other methods in almost all cases. The performance gap between CTRL and other methods is larger on CIFAR-100 than on CIFAR-10. Compared with CL, the disclosed label error detection method is more robust to the increase in the number of classes because it does not need to perform any | [symbol] |×| [symbol] | matrix calculation as CL does. Tables IV (see FIG. 12) and V (see FIG. 13) show results for Food-101 and Fashion-MNIST, respectively. An α of 0 was used for Food-101, and an α of 0.5 for Fashion-MNIST. On Food-101, CTRL outperforms other methods on mask and model accuracy in all cases except when there is no noise in the dataset. In that case, the final retrained model by CTRL still has a test accuracy close to the best model. The Fashion-MNIST classification task is relatively simple. It has 10 classes and sufficient training samples for each class. Models trained by different methods generally have test accuracy gaps within 1%.

To train models on the CIFAR-10 dataset, one GPU and two 4 GB CPU cores were used. It takes around five hours to train an NN from scratch on the vanilla dataset with the example's choice of training hyperparameters. The baseline, Co-teaching, and Mixup methods only need one round of training. CL and CTRL require two rounds: one for mask computation and one for retraining. The total time cost for Co-teaching is around 2× the vanilla training time because it trains two models simultaneously. For Mixup, the total time cost is approximately 1.5× the vanilla time cost. The time cost for mask computation varies by method. CL uses 4-fold cross-validation by default, which triples the training time. After CL cross-validates the training set, it just needs seconds to compute the mask. CTRL only needs one-time full training before mask calculation, though it needs extra time and space to record and save the training losses. Its NN training time in the first round is approximately 1.5× the vanilla training time. K-means takes a few seconds to run on a full loss matrix. Its total time cost scales with the number of candidate clustering parameter sets. As disclosed herein, the disclosed technique utilizes four clustering parameters: (k, s, w, t). These parameters have 18 combinations in all. In addition, CTRL also needs seconds to calculate the Silhouette Score and masked training accuracy, as defined in (1). In summary, complete mask calculation takes on the order of 20 minutes. Thus, CL's total training and retraining time is about 4× the vanilla time, and CTRL takes approximately 2.5× the vanilla time and extra space to store the loss matrix. Time complexity ratios between methods are similar for other datasets.

### Tabular Datasets

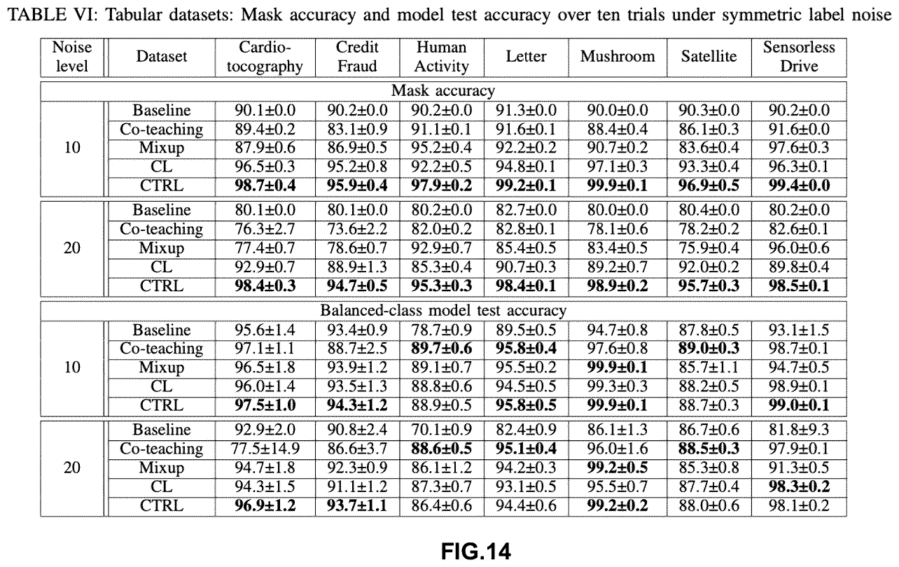

Experiments with tabular datasets follow a similar workflow. However, they involve some additional data processing such as scaling and one-hot encoding. Since NNs exhibit less stable behavior on tabular datasets, we perform ten trials for label error detection and retraining. Table VI (see FIG. 14) shows mean mask accuracy and retrained balanced-class test accuracy under 10% and 20% symmetric noise. In label error detection, CTRL outperforms other methods in all cases. Its superiority increases as labels become noisier. CTRL also performs better on model test accuracy for most datasets. However, although CTRL finds masks with more than 95% accuracy, it still underperforms Co-teaching in model training on Human Activity Recognition and Satellite, in which Co-teaching learns fewer training samples than other methods (based on mask accuracy). These two datasets are also the hardest to learn when noise is present; i.e., the methods achieve accuracies in the 80% range on these two but in the 90% range on the others. Thus, it is better to drop all confusing samples in datasets like Human Activity Recognition and Satellite.

### Real-World Noisy Datasets

CTRL was also run on Animal-10N and Food-101N: datasets that contain real-world labeling errors in the training sets. They have clean test sets. Animal-10N contains five pairs of confusing animals crawled from online search engines. Food-101N contains images of food recipes classified in 101 classes, also collected from the Internet. Table VII, shown below, shows a summary of the results. α was set to 0 for both datasets. CTRL's estimated noise rates are close to those estimated by the dataset creators. The balanced-class accuracies also show that models trained on cleaned data perform better than models trained using the original noisy data.

TABLE VII
Real-world dataset results

| | Animal-10N | Food-101N |
|---|---|---|
| Author est. noise rate | 8% | 20% |
| CTRL est. noise rate | 7.6% | 15.9% |
| Test acc. bef. clean | 84.5 ± 0.7% | 75.8 ± 1.0% |
| Test acc. aft. clean | 85.7 ± 0.2% | 78.8 ± 0.1% |

### Ablation Studies

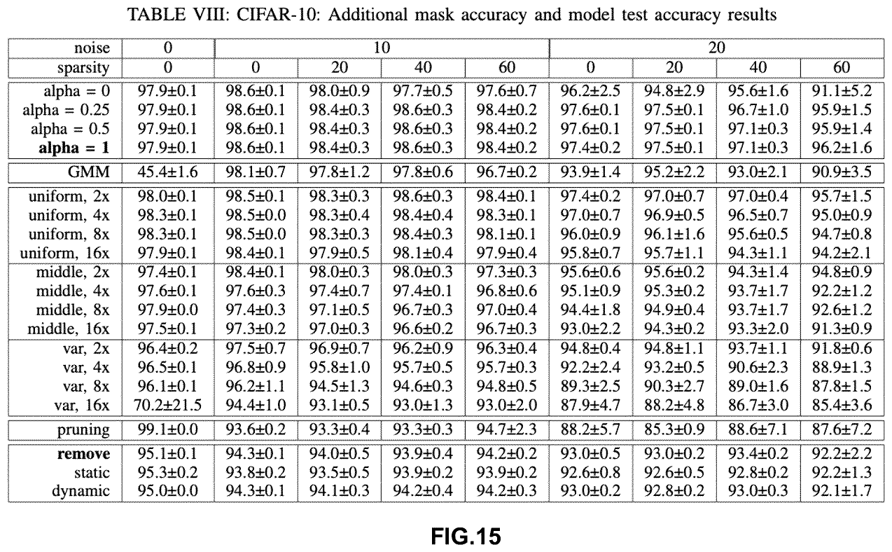

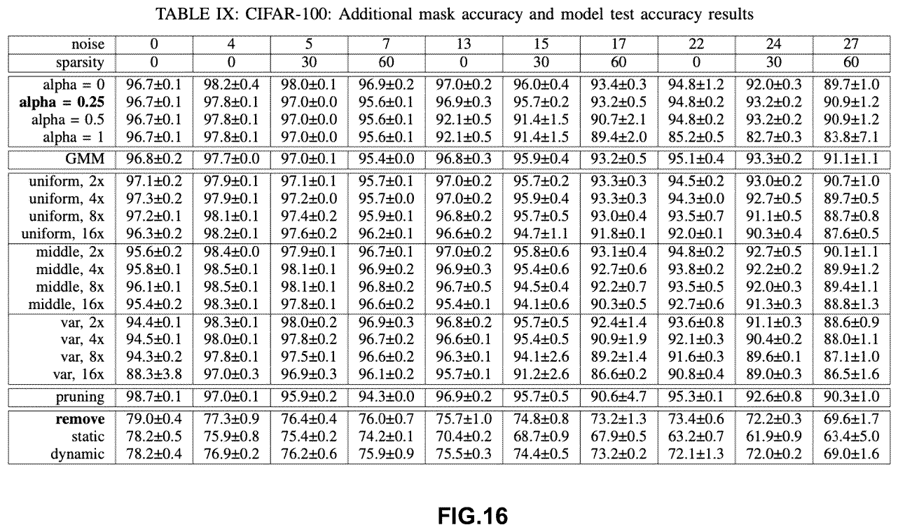

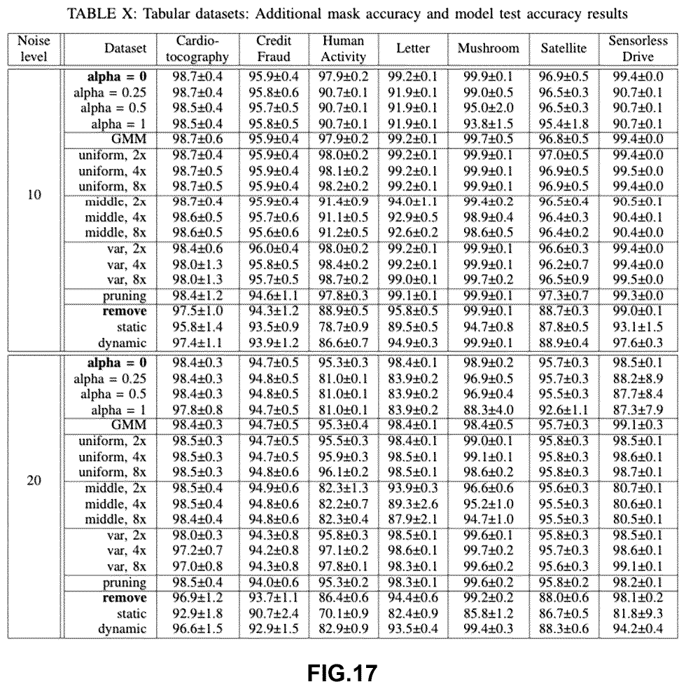

Tables VIII (FIG. 15), IX (FIG. 16), and X (FIG. 17) present results for some additional experiments on CIFAR and tabular datasets. Shown in bold are rows that were reported in herein with respect to image datasets and tabular datasets. The following was tested:
Use of different α values to determine the best mask, as described in (1).
Use of GMM as the core clustering algorithm.
Use of a subset of the loss matrix for label error detection. Three subsampling methods were considered: sample uniformly, sample the middle n epochs, and sample the top n epochs with high intra-epoch loss variance. The size of the loss matrix was reduced by different ratios.
Application of iterative NN pruning during the first training round.
Retraining of the model by replacing noisy labels with model predictions, either dynamically or statically.

α, GMM, subsampling, and pruning are involved in the label error detection process. Hence, the mask accuracy was reported for these methods. Label replacement occurs in the cleaning and model retraining phase. Hence, the retrained model test accuracy using the mask from Tables II, III, and VI was reported. To implement iterative pruning, the NN was pruned and unpruned by 60% from the 10%-th epoch to the 90%-th epoch alternatively, with a cyclic period of 20 epochs. To implement static label replacement, the values of noisy labels that CTRL detects were replace with the predictions made by the model trained in the first round. To implement dynamic label replacement, only noisy labels were included from the 50%-th epoch to the 90%-th epoch during retraining. Their values are updated by the model's prediction at every epoch.

For CIFAR datasets, different α's result in similar masks when the noise rate is low. The choice of α becomes more important when more noisy labels are present because models start to overfit smaller portions of the training samples. For tabular datasets, setting α to 0 yields better mask accuracy, likely caused by less stable loss convergence. With the selection of α, one gets comparable detection accuracies in most experiments if one replaces the core clustering algorithm with GMM, except being less stable in a few cases. On CIFAR, CTRL generally performs better when it samples more points from the loss curve. This is especially helpful when noise rates are high. However, since a mean filter of size 5 was applied on the loss curve before mask computation, it was found that uniformly subsampling the loss trajectory by up to 8× only degrades the mask accuracy by less than 2 points. Subsampling can even improve CTRL's detection accuracy in many cases on the tabular datasets, indicating that tabular datasets suffer from high-frequency signals in their loss curves. To increase the loss difference between clean and noisy labels, Iterative pruning was applied to NNs. However, NN pruning only helps in a few cases. In addition to simply removing noisy labels, including noisy labels during model retraining but replacing them with the model predictions, either statically or dynamically, was tested. It was found that simple filtering outperforms label replacements in most cases.

The presently disclosed techniques can be readily utilized to, e.g., clean noisy labels in datasets. Those datasets may vary greatly. For example, in some embodiments, the datasets may be, e.g., internal data, published data, etc. In one example, the techniques can be used to improve data used to help train machine learning models. The techniques may be used in healthcare application, such as detecting clerical errors, outliers, etc., for healthcare companies and/or hospitals. The techniques may be used for quality control in various industries, such as in packaging or manufacturing, to provide better results with noisy data, such as with image recognition and/or other computer vision tasks during production. In some embodiments, systems may generate an alert and/or send a message, when an error is detected. In some embodiments, systems may suggest a correction when an error is detected, Such suggested corrections may be accepted or rejected (e.g., if a doctor enters in data that the presently disclosed technique detects as a mistake, the system may suggest a correction, which the doctor may then approve or reject). In various packaging/manufacturing environments, systems may quarantine the items for which an error was detected. The quarantined materials may allow the QC algorithm to be further trained or improved to correctly identify the error, or if the error was incorrectly identified, may be used to train the disclosed system to improve its detection accuracy.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed:

1. A method for training a neural network to detect label errors, comprising:
training a neural network on a training dataset, wherein the neural network produces one or more training loss data samples for each epoch of a plurality of training epochs, wherein training includes:
recording training loss of each data sample in every epoch; and
creating a loss matrix, wherein the loss matrix is constructed as: |training loss samples|×|epochs|; and
forming a refined neural network by refining the neural network, where refining includes applying a clustering algorithm to the loss matrix, the clustering algorithm configured to separate samples into either a category of clean labels or noisy labels.

2. The method of claim 1, further comprising using a noise generator to create the training dataset.

3. The method of claim 1, further comprising removing noisy labels before a subsequent period of training.

4. The method of claim 3, further comprising dynamically replacing noisy labels with a prediction of a neural network during a period of training.

5. The method of claim 3, further comprising statically replacing noisy labels with a prediction of a neural network, updated before a period of training by using the training of a previous round of the neural network.

6. The method of claim 1, further comprising using the refined neural network to classify received data as defective.

7. The method of claim 6, wherein classifying the received data as defecting includes using the refined neural network to classify an image of a label as a label defect.

8. The method of claim 6, wherein classifying the received data as defecting includes using the refined neural network to classify data in a tabular dataset as defective.

9. A system, comprising:
at least one processing unit; and
at least one non-transitory computer readable storage medium storing instructions that, when executed by the at least one processing unit, cause the at least one processing unit to, collectively:
train a neural network on a training dataset, wherein the neural network produces training loss data samples for an epoch, wherein training includes:
recording training loss of each data sample in every epoch; and
creating a loss matrix, wherein the loss matrix is constructed as: |training loss samples|×|epochs|; and
form a refined neural network by refining the neural network, where refining includes applying a clustering algorithm to the loss matrix, the clustering algorithm configured to separate samples into either a category of clean labels or noisy labels.

10. The system of claim 9, wherein the instructions further cause the at least one processing unit to use a noise generator to create the training dataset.

11. The system of claim 9, wherein the refined neural network is transmitted to a remote processing unit for use in classifying data as including an error or being free of errors.

12. The system of claim 11, wherein the refined neural network is transmitted to a remote processing unit for use in classifying images as clean labels or noisy labels.

13. The system of claim 11, wherein the refined neural network is transmitted to a remote processing unit for use in classifying data in a tabular dataset as including an error or being free of errors.

14. The system of claim 9, further comprising a requestor computing device, the requestor computing device configured to send a request to the at least one processing unit to classify data as including an error or being free of errors.

15. The system of claim 14, wherein the requestor computing device is configured to send a request to the at least one processing unit to classify an image of a label as a clean label or a noisy label.

16. The system of claim 14, wherein the requestor computing device is configured to send a request to the at least one processing unit to classify data in a tabular dataset as including an error or begin free of errors.

17. A non-transitory computer readable medium, containing instructions thereon that, when executed by at least one processing unit, cause the at least one processing unit to, collectively:
train a neural network on the noisy training dataset, wherein the neural network produces training loss data samples for an epoch, wherein training includes:
recording training loss of each data sample in every epoch; and
creating a loss matrix, wherein the loss matrix is constructed as: |training loss samples|×|epochs|; and
refine the neural network by applying a clustering algorithm to the loss matrix, wherein the clustering algorithm creates separated groups of either clean labels or noisy labels.
